(19) United States
(12) Patent Application Publication
(10) Pub. No.: US 2013/0145920 A1
(43) Pub. Date: Jun. 13, 2013

(54) WATER LEAKAGE PREVENTION TOOL, SAXOPHONE, AND WIND INSTRUMENT

(71) Applicant: Yoshinari Takegami, Tokyo (JP)

(72) Inventor: Yoshinari Takegami, Tokyo (JP)

(73) Assignee: BACKS VERSE CO., LTD., Tokyo (JP)

(21) Appl. No.: 13/818,037

(22) PCT Filed: Aug. 20, 2010
(86) PCT No.: PCT/JP2010/064119

§ 371 Date: Feb. 20, 2013

(51) Int. Cl. G10D 7/08; G10D 9/00

(52) U.S. Cl. CPC G10D 7/08; G10D 9/00
USPC 84/385 R

(57) ABSTRACT

A saxophone includes a roughly U-shaped first pipe 13 communicating with a bell 11, a second pipe 15 communicating with the first pipe 13, a mouthpiece 21, and a neck 17, and a water guiding means 40 is provided between the mouthpiece 21 and the first pipe 13 to guide the fluid within blown breath to flow down through a specified position within the second pipe 15.

### TECHNICAL FIELD

The present invention relates to a saxophone equipped with a roughly U-shaped first pipe that communicates with a bell, other wind instruments and a water leakage prevention tool attachable to these.

### BACKGROUND ART

Saxophones, such as curved soprano saxophones, alto saxophones, and tenor saxophones, include a roughly U-shaped first pipe communicating with a bell, and a second pipe, which communicates with the first pipe and into which breath blown into a mouthpiece flows through a neck.

By operating many key touches and levers of a saxophone while blowing breath into the mouthpiece, a large number of tone holes provided on the second pipe and the first pipe are opened or closed to play desired music. With such a saxophone, the mouthpiece is placed close to a player, and a bell is placed on far side from the player, and music is most often played for a long time in a state where the second pipe on a side closer to the neck is set, lightly inclined in the forward direction with respect to the vertical direction.

When music is played, the breath blown from a reed into the mouthpiece flows into the second pipe through the neck. Since breath contains water vapor, the breath blown in condenses within the saxophone, and turns into water. Condensed fluid and saliva (hereinafter collectively referred to as water or fluid, as required) gradually accumulate in the first pipe, and discharged from the bell by inclining the instrument, for example, during or after musical performance.

### SUMMARY OF INVENTION

### Technical Problem

However, the fluid having condensed in the mouthpiece or the neck, or at the upper part of the second pipe, attaches to the internal wall of the second pipe as water droplets, then flow down by gravity. This water reaches tone hole openings of the second pipe, and leaks to outside from the second pipe when the tone hole openings are opened or half-opened.

If the tone holes are opened or half-opened in a state where water droplets exist or remain in or near the tone hole openings, water outbursts to outside with the burst of air flow through the tone holes. From high F, high E b, high D tone holes, which are provided on the front side closer to the neck of the second pipe, in particular, water droplets tend to move toward the front side due to breath blown in, thus allowing water to leak easily.

If condensed fluid flows out of the saxophone, key touches, levers, etc. get wet, causing the hands and fingers holding the saxophone to slip easily, or the clothes of the player to get wet, and thus deteriorating the performance environment.

Due to attachment of condensed fluid to pads, which open/close the tone holes, the pads may degrade or adhere to the tone holes. With the pads that are actuated in the opening direction and opened by the actuating power when the key touches and levers are operated, trouble in performance occurs if they adhere to the tone holes. For example, the tone holes might not open, with the pads remaining adhered even if key touches or levers are operated. Furthermore, on the outer surface of the saxophone, contamination due to fluid, degradation of plating, or rusting may occur.

As a result, the number of times of maintenance may increase, or the life of pads or the instrument itself may be shortened, meaning that the durability of the saxophone decreases. In particular, as a result of outflow of condensed fluid to outside of the saxophone, the player is placed under significant mental stress.

Such a problem of leakage of fluid might occur not only with the saxophone but also with other wind instruments.

Under such circumstances, it is an object of the present invention to provide a water leakage prevention tool, and a saxophone and other wind instruments capable of preventing fluid that flows down from the mouthpiece, neck, and the upper part of pipe body, etc. from leaking outside from tone holes during use.

### Solution to Problem

The saxophone achieving the above objective is characterized in that it includes a water guiding means for guiding fluid in breath to the side of the first pipe between the mouthpiece and the first pipe, in addition to a roughly U-shaped first pipe communicating with a bell and a second pipe, which communicates with the first pipe and into which breath blown into the mouthpiece flows through the neck, and that the water guiding means allows the fluid to flow down within the second pipe through a position that is different from the tone hole openings.

Wind instruments that achieve the above objective are characterized in that they include a water guiding means, within a pipe body, for guiding fluid to the bottom side of the pipe body, in addition to a pipe body, which includes tone holes and into which breath flows from top side in vertically arranged state, and that the water guiding means allows the fluid to flow down within the pipe body through a position different from the tone hole openings.

A water leakage prevention tool for saxophones achieving the above objective is attached to saxophones, which include a roughly U-shaped first pipe communicating with a bell and a second pipe, which communicates with the first pipe and into which breath blown into the mouthpiece flows through the neck, and is characterized in that the tool is equipped with a water guiding means that is attached between the mouthpiece and the first pipe to guide the fluid within breath to the side of the first pipe, and that the water guiding means allows the fluid to flow down within the second pipe through a position different from the tone hole openings.

A water leakage prevention tool for wind instruments achieving the above objective is characterized in that it is structured attachable to wind instruments equipped with a pipe body, which has tone holes and into which breath flows from the top side in a state placed vertically, that it is equipped with a water guiding means to be attached to the pipe body to guide the fluid within breath to the down side of the pipe body, and that the water guiding means allows the fluid to flow down within the pipe body through a position different from the tone hole openings.

### Effect of Invention

A saxophone and wind instruments according to the present invention include a water guiding means for guiding the fluid within breath blown in. Consequently, the fluid, namely the condensation of water vapor in the breath blown into the mouthpiece during use, can be made to flow down by the water guiding means through a position different from the tone hole openings, and the fluid that reaches the tone hole openings can thus be decreased. As a result, leakage of fluid to outside through the tone hole openings during use can be decreased or prevented.

According to the water leakage prevention tool of the present invention, as a result of attaching it to a saxophone or other wind instruments, the water guiding means for guiding the fluid within breath is placed within the pipe. Consequently, the fluid, namely the condensation of water vapor within breath blown into the mouthpiece during use, can be made to flow down by the water guiding means through a position different from the tone hole openings, and the water reaching the tone hole openings can thus be decreased. As a result, leakage of fluid from within the pipe to outside through the tone hole openings during use can be decreased or prevented.

### BRIEF DESCRIPTION OF DRAWINGS

FIG. 1 is a schematic side view of a saxophone according to an embodiment of the present invention.

FIG. 2 is a schematic front view of the saxophone according to the embodiment.

FIG. 3 is a partial longitudinal sectional view of a second pipe of the saxophone according to the embodiment.

FIG. 4(a) is a front view showing the state before a water leakage prevention tool according to a first embodiment is attached, FIG. 4(b) is an oblique perspective view of the water leakage prevention tool, and FIG. 4(c) is a developed view of a saxophone to which the water leakage prevention tool is attached.

FIG. 5 is a partial longitudinal sectional view of a saxophone according to a second embodiment.

FIG. 6 is a partial longitudinal sectional view of a saxophone according to a third embodiment.

FIG. 7(a) to FIG. 7(d) are partial longitudinal sectional views showing variations of the saxophone according to the third embodiment.

FIG. 8(a) is a partial longitudinal sectional view of a saxophone according to a fourth embodiment, and FIG. 8(b) is a typical variation of a cylindrical body in the fourth embodiment.

FIG. 9(a) is a partial longitudinal sectional view of a saxophone according to a fifth embodiment, and FIG. 9(b) is a developed view of a part of a second pipe of the saxophone in the fifth embodiment.

FIG. 10(a) is a partial longitudinal sectional view of a saxophone according to a sixth embodiment, and FIG. 10(b) is a developed view of a part of a second pipe of the saxophone according to the sixth embodiment.

FIG. 11 is a transverse sectional view of the saxophone according to the sixth embodiment.

FIG. 12 is a partial sectional view showing the state of attaching of a linear member to the saxophone according to the sixth embodiment.

FIG. 13 is a transverse sectional view showing a typical variation of the saxophone according to the sixth embodiment.

FIG. 14(a) is a partial longitudinal sectional view showing another typical variation of the saxophone according to the sixth embodiment, and FIG. 14(b) is a developed view of a part of the second pipe shown in 14(a).

FIG. 15(a) is a partial longitudinal sectional view showing another typical variation of the saxophone according to the sixth embodiment, and FIG. 15(b) is a developed view of a part of the second pipe shown in 15(a).

### DESCRIPTION OF EMBODIMENTS

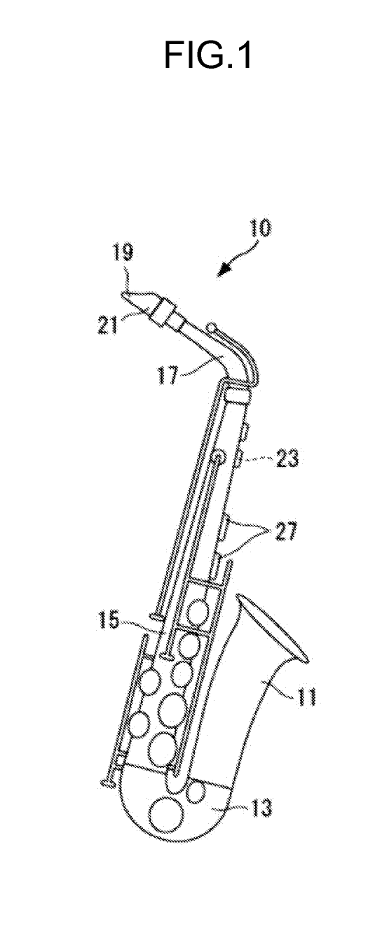

Some of the embodiments of the present invention will hereinafter be described by referring to FIGS. 1 to 15.

### First Embodiment

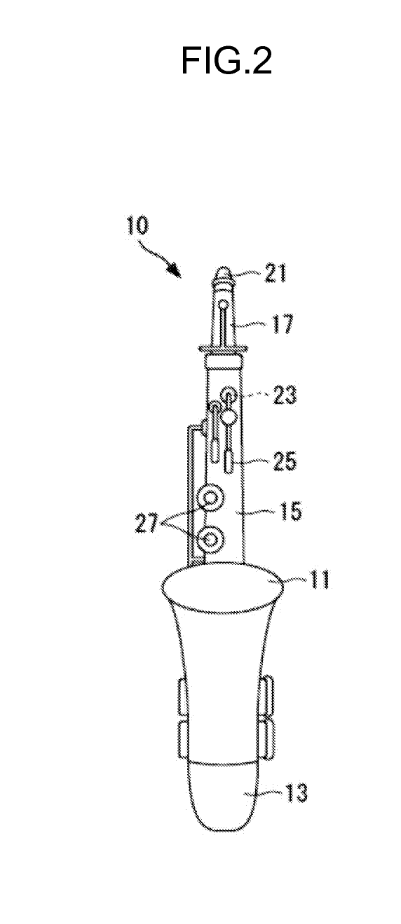

As shown in FIGS. 1 and 2, the saxophone 10 includes: a bell 11; a roughly U-shaped first pipe 13 connected to the bottom end of the bell 11 to communicate with the bell 11; a roughly linearly tapered second pipe 15 connected to an end of the first pipe 13, namely the end on the opposite side of the bell 11, to communicate with the first pipe 13; a roughly L-shaped neck 17 connected to the top end of the second pipe 15; and a mouthpiece 21 connected to the neck 17 and to which a reed 19 is mounted.

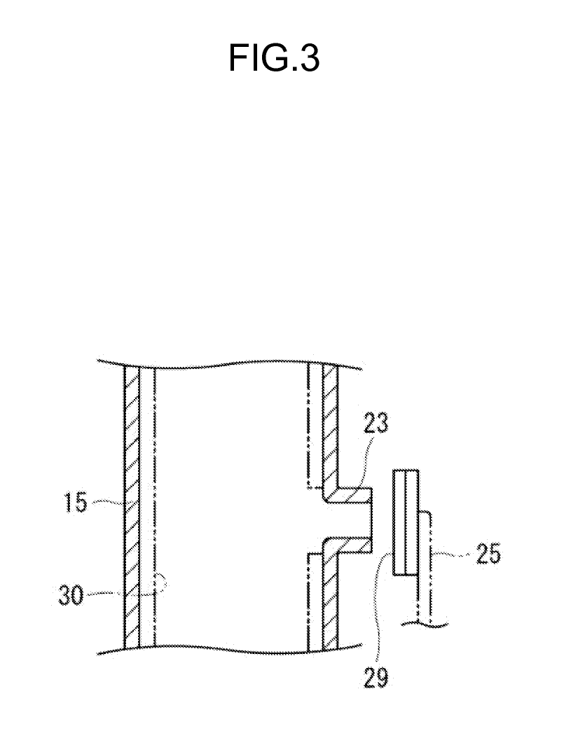

On side surfaces of the first pipe 13 and the second pipe 15, many soldered-type or drawn-type tone holes 23 are provided in open state as shown in FIG. 3. The peripheral wall of each tone hole 23 is formed protruding outward from the outer surface of the first pipe 13 or the second pipe 15. Each tone hole 23 is not provided in a fixed orientation in the circumferential direction of the first pipe 13 and the second pipe 15, but provided in different orientations for reasons of operational ease, appearance and design.

At a position corresponding to each of the tone holes 23, a pad 29 that is operable using a lever 25 and a key touch 27 is attached to allow each tone hole 23 to be opened, half-opened, or closed.

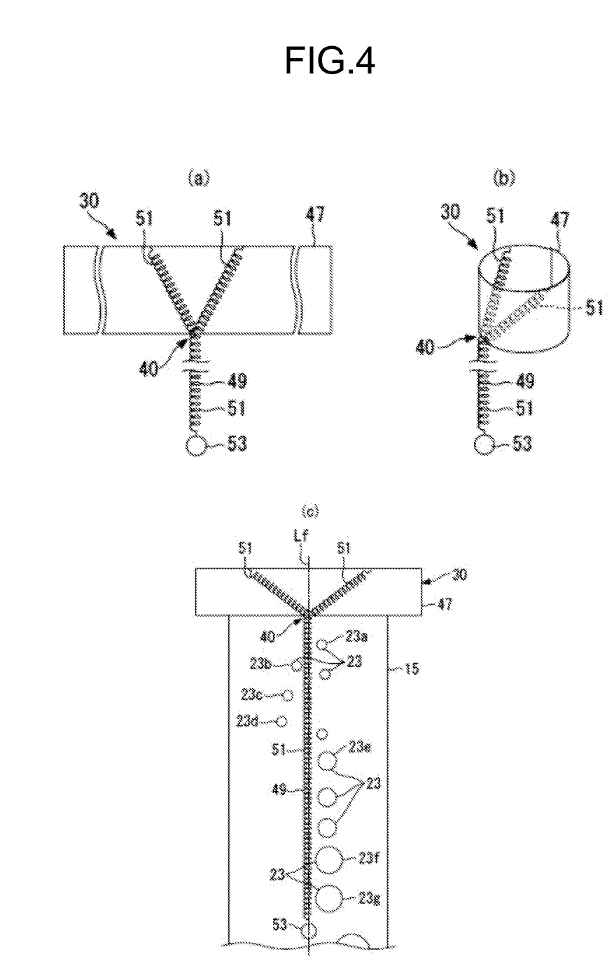

FIG. 4(a) to (c) show a water leakage prevention tool 30 for saxophones in this embodiment. The water leakage prevention tool 30 for saxophones according to this embodiment includes: a fixing member 47 that can be fixed to a connecting part between the neck 17 and the second pipe 15; and a suspended member 49 that is connected to the fixing member 47 and can be suspended as a water guiding means within the second pipe 15.

The fixing member 47 is made of an elastic plate material such as resin and metal that can be latched to the inner wall surface of the saxophone 10 by elastic force, and is formed in a shape of a band whose length in the vertical direction is short and whose width is longer than the inner perimeter of the neck 17, for example. This fixing member 47 is arranged on the inner wall surface of the neck 17 in a state elastically deformed into a cylindrical shape.

The suspended member 49 is in a shape where a linear member 51 formed by being spirally wound up like a tension spring is branched in three directions to form a Y shape. Two of the branches of the linear member 51 are arranged so as to contact the inner surface of the fixing member 47, and each edge and the point of intersection are fastened to the fixing member 47, for example.

At the bottom end of one branch of the linear member 51, a weight 53 for extending and arranging the linear member 51 appropriately by gravity is fastened. A weight 53 made of rubber, for example, is used favorably because damage on the inner surface of the saxophone 10 can be prevented.

The two branches of the linear member 51, to which a weight 53 is not attached, are fastened in a manner where the distance between the two at the top edge of the fixing member 47 becomes narrower in the downward direction. By fastening the two branches of the linear member 51 at positions higher than the branching point in a manner where the distance between them becomes narrower in the downward direction, fluid is easily collected around the branching point when the fluid having attached to the fixing member between the branches of the linear members 51 flows down.

It is desirable that the bottom end of the branch of the linear member 51, to which the weight 53 is fastened, be placed lower than the B tone hole 23e, favorably lower than the G tone hole 23f, or more favorably lower than the G# tone hole 23g. All of the B tone hole 23e, G tone hole 23f, and G# tone hole 23g, are susceptible to leakage of fluid during performance. If water can be guided to a place lower than these tone holes 23, leakage of fluid can be decreased or prevented.

It is favorable that the branching point of the two branches of the linear member 51 is placed on or near a front center line Lf.

The front center line Lf in this case is a virtual line on the inner surface of the second pipe 15, which comes on the front side while the instrument is being played in a state where the bell 11, first pipe 13, and neck 17 are connected. This front center line Lf passes through a point where the extension of the linear central axis of the neck 17 on the side of the mouthpiece 21 reaches the inner surface of the second pipe 15 on the front side, or its virtual extended surface, and extends along, and mostly in parallel to, the central axis of the second pipe 15 in the longitudinal direction of the second pipe 15. Since this front center line Lf is laid out at least between the high D tone hole 23d and the B tone hole 23e in the longitudinal direction, it can be regarded as mostly identical, despite slight difference shown due to varying conditions of how the player supports the saxophone 10.

To attach this water leakage prevention tool 30 for saxophones to the saxophone 10, the neck 17 is made to be in a state detached from the second pipe 15 first. The fixing member 47 is made to have a diameter smaller than the inner diameter of the neck 17 on the bottom side or than the inner diameter of the second pipe 15 on the top side, and inserted into the neck 17 or the second pipe 15. At this time, the branching point of the linear members 51 is made to come on or near the front center line Lf.

When the fixing member 47 is then released, its outer diameter expands by elastic force, and the outer surface is crimped and fastened to the inner wall surface of the neck 17 or the inner surface of the second pipe 15 by elastic force. In addition, by inserting the weight 53 and the linear member 51 to which the weight 53 is fastened into the second pipe 15, and connecting the neck 17 to the second pipe 15, mounting is completed.

FIG. 4(b) and FIG. 4(c) show the state where the water leakage prevention tool 30 for saxophones is attached. In FIG. 4(b), the second pipe 15 is not shown, whereas FIG. 4(c) shows the state where the second pipe 15 is developed. The left and the right edges of the second pipe 15 in the FIGS. are continuous in actual state.

To play music using the saxophone 10 to which the water leakage prevention tool 30 for saxophones described above is attached, it is only necessary to use the instrument in exactly the same way as when the tool is not attached. During performance, breath is blown from the reed into the mouthpiece 21, and within the mouthpiece 21 and the neck 17, water vapor contained in the breath condenses into water droplets. This fluid flows down on the surface of the fixing member 47 by gravity, and consequently gathers at the branching point, guided by the branched linear member 51. As a result of attachment of this fluid to the linear member 51 suspended on the side of the first pipe 13, the fluid can flow down along the linear member 51. Consequently, the fluid can flow down on the side of the first pipe 13 without reaching the high F#, high F, high E b, and high D tone holes, 23a, 23b, 23c, 23d provided on the top side of the second pipe, and furthermore without reaching the left-side tone holes 23 of the second pipe 15.

The fluid flowing down inside the second pipe 15 gradually accumulates in the first pipe 13, and is discharged during or after performance.

With the saxophone 10 as described above, thanks to the water leakage prevention tool 30 attached inside, the fluid within the breath can attach to the water leakage prevention tool 30 placed at a position other than the places of tone hole 23 openings on the second pipe 15, and is made to flow down. Consequently, the fluid, namely the condensation of water vapor blown into the mouthpiece 21, is prevented from becoming large water drops and reaching the tone hole 23 openings of the second pipe 15, or the amount of such fluid can be decreased.

As a result, leakage of fluid from inside the saxophone 10 to outside through the tone hole 23 openings during use can be decreased or prevented. In particular, burst of large water drops out of the tone holes 23 provided on the top end side of the second pipe 15, which occurs when they are opened due to rushing of air flow from the tone holes 23, can be prevented.

Furthermore, even if the tool is attached as described above, there is no adverse effect on the sound of the saxophone 10, and the instrument can be played without any problems.

The above embodiment can be modified as required within the scope of the present invention. For example, in the above embodiment, the water guiding means is made only of the suspended member 49 suspended within the second pipe 15, but it is also possible to use it along with other water guiding means 40 according to other embodiments.

In the above embodiment, the water collecting portion provided in the fixing member 47 was formed with the linear member 51 extending in two directions within the suspended member 49, but it is also possible to form one in the fixing member 47 using streaky inward protrusions made of a resin, etc., with the distance in lower part made to become narrower.

In the above embodiment, the linear member 51 formed by winding it in a spiral manner like a tension spring was used. However, any long members in a form other than that, such as uncoiled linear members, bodies in a shape of a rod, and bodies in a shape of a plate, can be used. Any long members can be used as a water leakage prevention tool for saxophones, suspended in the second pipe 15 as in the case of the above embodiment, provided that they can be deformed and that fluid can be made to attach to them.

Furthermore, in the above embodiment, the branching point of the linear member 51, which functions as water collecting portion, was provided at a place higher than the tone holes 23 of the second pipe 15. However, the branching part may also be provided at a place lower than some of the upper tone holes 23 provided in the second pipe 15. In this case, it is also possible to arrange the linear member 51 extending down to the branching part on different sides with respect to the tone holes 23. Furthermore, it is also possible to form water collecting portion by fastening one end of a piece of linear member 51 to the fixing member 47 and fastening a weight 53 to the other end. In addition, it is also possible to form water collecting portion by using a linear member 51 branching in four or more directions, with the linear member 51 extending in three or more directions forming a water collecting portion.

### Second embodiment

A second embodiment shows an example of a saxophone 10 equipped with a water guiding means.

With this saxophone 10, some or all of the tone holes 23 of the second pipe 15 are of a soldered type. The water guiding means 40 is provided to each of some or all of the tone holes 23 of the second pipe 15. The water guiding means may be provided to high F, high E b, and high D tone holes 23b, 23c, 23d, for example.

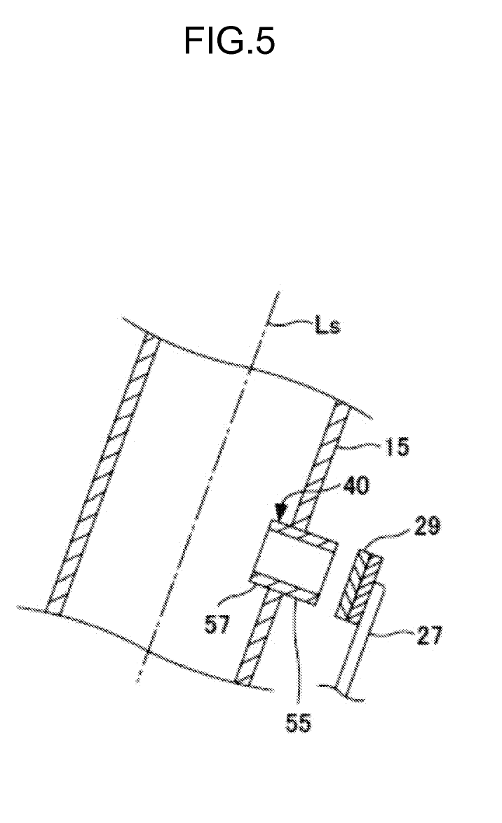

Specifically, as shown in FIG. 5, as a result of forming a peripheral wall 55 for each of the tone holes 23 so that it protrudes inward from the inner wall surface of the second pipe 15, protruding wall 57 surrounding the periphery of the tone hole 23 openings is formed. This protruding wall 57 constitutes the water guiding means 40. A part of or the entire inner wall surface of the second pipe 15 except for the protruding wall 57 may be made to be a hydrophilically treated surface, for example, to allow it to be more hydrophilic than the protruding wall 57.

With such a saxophone 10, fluid having condensed at the mouthpiece 21, neck 17 and the upper part of second pipe 15 during use flows down along the inner wall of the second pipe 15. Once the water reaches the protruding wall 57, it is guided along the outer periphery of the protruding wall 57, and flows down to the side of the first pipe 13. As a result, water droplets that have flowed down can be prevented from flowing into the opening of each tone hole 23, and thus the amount of water leaking from each tone hole 23 to outside can be decreased.

The above embodiment was also an example where protruding wall 57 only was provided as the water guiding means, but it is possible to use it along with a water guiding means 40 according to other embodiments.

An example where tone hole peripheral wall 55 was protruding inward as the protruding wall 57 was described above. However, to provide tone hole peripheral wall 55 not protruding inward, a ring-shaped protruding wall made of a different member may be bonded around the tone hole 23 openings on the inner wall surface of the second pipe 15. In this case, by allowing the wall thickness to be as thin as a plate, the protruding wall may be made to have small height. Even such a structure can guide the fluid flowing down satisfactorily.

### Third embodiment

With a saxophone 10 in a third embodiment, the water guiding means 40 is provided to some or all of the tone holes 23 of the second pipe 15. The water guiding means 40 may be provided to high F, high E b, and high D tone holes 23b, 23c, 23d.

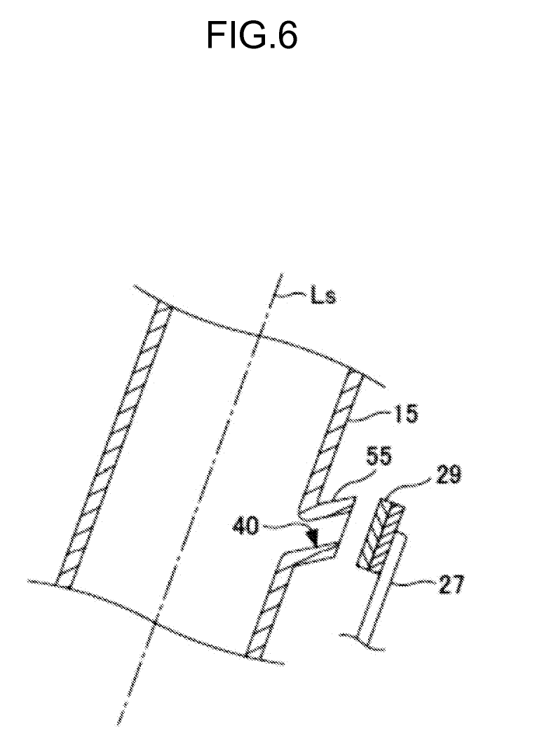

As shown in FIG. 6, in the water guiding means 40, the tone hole peripheral wall 55 of the tone hole 23 is provided, being slanted with respect to the axis Ls of the second pipe 15, with the external side of each tone hole 23 facing upward. In this case, the periphery of the tone hole 23 on the external side is formed on a plane in parallel to the axis Ls of the second pipe 15, and the opening on the external side is in a shape of an ellipse.

With such a saxophone 10, water droplets flow down along the inner wall of the second pipe 15 during use, and reaches the opening of each tone hole 23. Since each tone hole peripheral wall 55 is slanted, the water droplets can flow down, being guided to the side of the first pipe 13 with certainty, without flowing toward the external side within the tone holes 23.

Consequently, the water droplets having flowed down can be prevented from flowing into each tone hole 23 opening, and thus the amount of water leaking from each tone hole 23 to outside can be decreased. Furthermore adverse effect on the sound of the saxophone 10 can also be prevented.

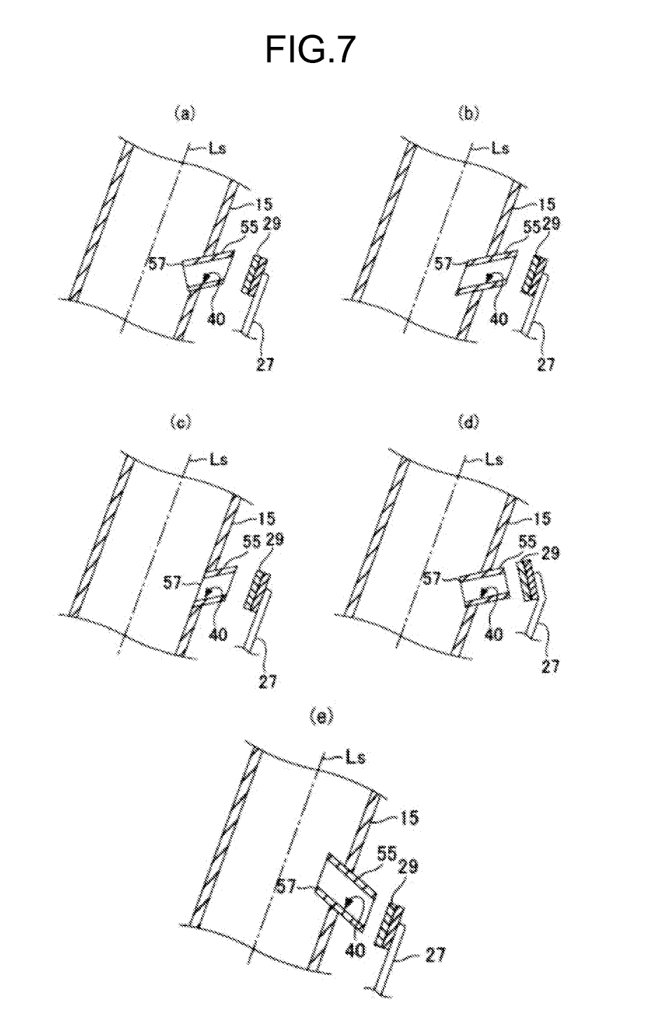

In the above embodiment, the example where slanted tone hole peripheral wall 55 only was provided as the water guiding means was described, but it can also be used along with a water guiding means 40 according to other embodiments. In FIG. 7(a) for example, the tone holes 23 are made to be of a soldered type, and the tone hole peripheral wall 55 is formed slanted, with the external side of the tone holes 23 remaining at a higher position. Here, it is also possible, as in the second embodiment, to form the protruding wall 57 surrounding the periphery of the opening by providing tone hole peripheral wall 55 protruding inward from the inner wall surface of the second pipe 15. In this tone hole 23, the periphery on the external side is formed on a plane in parallel to the axis Ls of the second pipe 15, and the periphery on the internal end of the protruding portion 57 is made to incline with respect to the axis Ls to prevent it from forming a shape having an acute angle.

As shown in FIG. 7(b), with the tone hole peripheral wall 55 formed as a soldered type, the periphery at the inner end of the protruding wall 57 provided protruding inward from the inner wall surface of the second pipe 15 may be formed on a plane in parallel to the axis Ls of the second pipe 15. In this example, the openings at the external and the inner ends are in a shape of an ellipse.

As shown in FIG. 7(c), it is also possible to form the tone hole peripheral wall 55, slanted with respect to the axis Ls of the second pipe 15, with the external side slanted upward, without allowing the end of the tone hole peripheral wall 55 formed as a soldered type to protrude inward from the wall surface of the second pipe 15.

As shown in FIG. 7(d), the external periphery of the tone hole peripheral wall 55 formed as a soldered type may not be formed on a plane parallel to the axis Ls of the second pipe 15, but may be formed on a virtual plane crossing orthogonal to the tone hall peripheral wall 55. In this case, the pad 29 supported by the lever 27 can be provided slanted so that its orientation matches that of the external part of the tone hole 23 to allow the tone hole 23 opening to be opened/closed using the pad 29.

In this way, the opening on the external side of the tone hole 23 can be in a shape of a rough circle, and not an ellipse, and consequently a sense of discomfort at opening/closing can be suppressed.

Furthermore, in the tone hole peripheral wall 55 formed as a soldered type as shown in FIG. 7(d), the end may be formed without being made to protrude inward from the wall surface of the second pipe 15, as in the case of the tone hole shown in FIG. 7(c).

As shown in FIG. 7(e), the tone hole peripheral wall 55 may be formed slanted so that the external side of the tone hole 23 comes to a lower position.

### Fourth embodiment

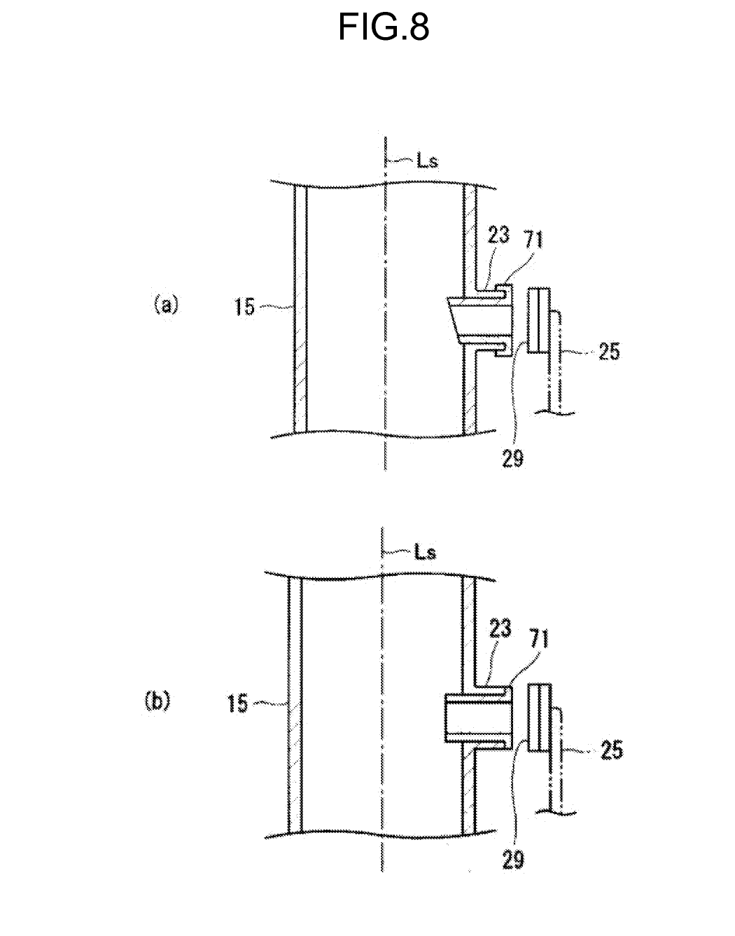

FIG. 8 shows a fourth embodiment, namely an example of a saxophone 10 provided with a water guiding means. The saxophone 10 in this embodiment is an example where a cylindrical body 71 as a water guiding means is attached to soldered-type or drawn-type tone holes 23 formed protruding in a direction orthogonal to the axis Ls of the second pipe 15.

The cylindrical body 71 shown in FIG. 8(a) is inserted into the tone hole peripheral wall 55 from outside, where a pad 29 is placed, and mostly closely attached to the inner surface. The external end portion is in a shape matching the external periphery of the tone hole peripheral wall 55, and is not allowed to enter into the tone hole 23. As a result of contact between the external portion of this cylindrical body 71 and the pad 29, the tone hole 23 can be closed tightly.

Meanwhile, the length of the cylindrical body 71 is longer than that of the protrusion of the tone hole peripheral wall 55, and the end portion of the cylindrical body 71 is placed protruding into the second pipe 15. The end portion that is placed inside the second pipe 15 is formed slanted with respect to the axial direction, and attached to the second pipe 15, with the top side protruding inward more than the bottom side.

Such a cylindrical body 71 may be attached to all of the tone holes 23 of the second pipe 15, or may be attached to high F#, high F, high E b, and high D tone holes 23a, 23b, 23c, 23d, where water leakage tends to occur often.

The materials of the cylindrical body 71 are not limited to specific ones, but may be metallic materials. They may also be resins for reasons that it is easily attachable and can be closely attached to the internal surface of the tone holes 23.

The saxophone 10 wherein such cylindrical bodies 71 are attached can suppress the amount of water leaking from each tone hole 23 of the second pipe 15, to which the cylindrical body 71 is mounted. In addition, adverse effect on the sound of the saxophone 10 can be prevented.

The shape of the cylindrical body 71 is not limited, but is changeable as required. For example, as shown in FIG. 8(b), one may be formed, with both ends formed orthogonal to its axial direction. In addition, the end portion placed at the external portion of the tone hole peripheral wall 55 can be made to have roughly the same diameter as the outer diameter of the tone hole 23 to improve visual quality.

In the second to the fourth embodiments described above, it is also favorable that the positions of the tone holes 23 in the neighborhood of the front center line Lf are deviated so that they are apart from the front center line Lf in the circumferential direction around the axis Ls of the second pipe 15.

### Fifth embodiment

The fifth embodiment is an example of a saxophone 10 to which a water guiding means is provided. By providing grooves along the connecting part between the neck 17 and the second pipe 15 and on the internal wall surface of the second pipe 15, the water guiding means 40 is formed.

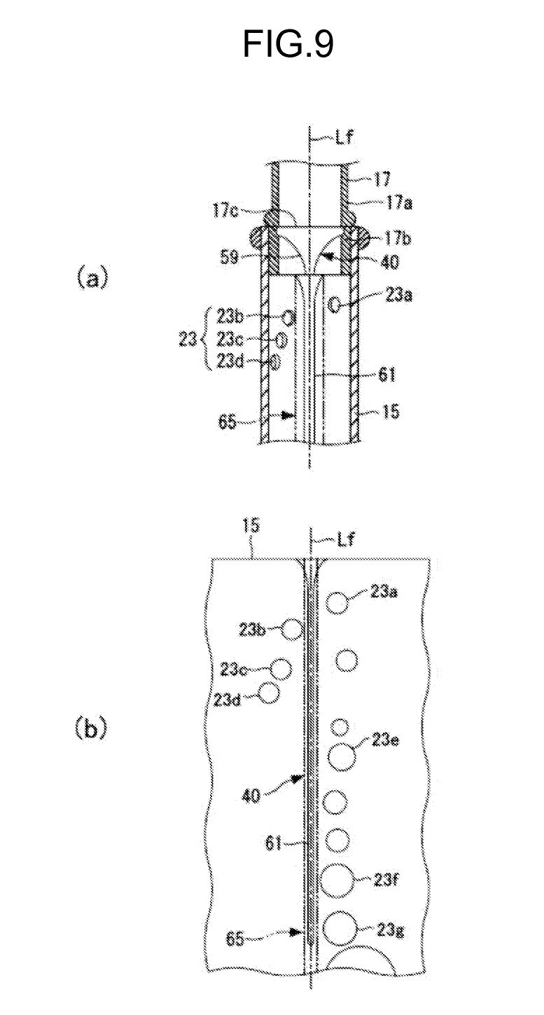

FIG. 9(a) shows the connecting part between the neck 17 and the second pipe 15, and FIG. 9(b) shows the state where the inside of the second pipe 15 is developed.

At the connecting part between the neck 17 and the second pipe 15 of this saxophone 10, step concave portion 59 as shown in FIG. 9(a) is formed along approximately half of the periphery on the front side and on the opposite side of the mouthpiece 21, and on the inner wall surface on the front side of the second pipe 15, a groove 61 is formed in succession to the step concave portion 59.

The step concave portion 59 of the neck 17 is roughly in a shape of an inversed triangle, and the portion along the front center line Lf is formed in a shape of a groove with the bottom end side opened. The top end of the step concave portion 59 is arranged widely on the lower side of the groove-shaped connection 17c formed between the neck main body 17a and the connecting end portion 17b in the circumferential direction.

The depth of the step concave portion 59 is not limited, but the depth ensuring sufficient use strength in a state where at least the neck 17 and the second pipe 15 are connected is desirable. It is also desirable that in a state of placement of the saxophone during use, the depth ensure that the fluid generated in the mouthpiece 21 and the top side of the neck 17 flows in and is guided into the groove-like portion on the lower side by the step on lower side of the step concave portion 59.

Furthermore, the gradient in the circumferential direction on the bottom side of the step concave portion 59 is not limited, provided that in the state of placement of the saxophone during use, the fluid generated in the mouthpiece 21 and on the top side of the neck 17 is allowed to flow down along the gradient on the bottom side when it flows into the step concave portion 59.

Meanwhile, on the internal wall surface on the front side of the second pipe 15, a front region 65 extending in a longitudinal direction along the axis Ls of the second pipe 15 is provided by adjusting the arrangement positions of some of the tone holes 23. This front region 65 is a virtual region laid out on the inner wall surface that is placed on the front side of the second pipe 15 during performance, and both side edges are allowed to be linear lines extending along the axis Ls of the second pipe 15.

In many saxophones 10, high F, high E b, and high D tone holes 23b, 23c, 23d and B, G, and G# tone holes 23e, 23f, 23g are placed, with their edges overlapped with each other in the vertical direction. In such saxophones 10, a front region like the one shown in this embodiment does not exist. However, by placing some of the tone holes, one or both of the high F and high E b tone holes 23b, 23c, for example, displaced in the circumferential direction of the second pipe 15, such virtual region 65 can be formed without having adverse effect on sound quality.

In this embodiment, the front region 65 is provided between an area including high F, high E b, and high D tone holes 23b, 23c, 23d and an area including B, G, and G# tone holes 23e, 23f, 23g, without contacting any of the tone holes 23. A front center line Lf is also in this front region 65.

A groove 61 within the second pipe 15 is provided in this front region 65. This groove 61 has a width roughly equal to that of the step concave portion 59 at the bottom end, and extends toward the first pipe 13 along the front center line Lf. By forming the position of the groove 61 adjacent to the step concave portion 59 of the neck 17 in a shape of an inversed triangle, water flowing down from the step concave portion 59 can be received without fail. For example, even if there is personal difference among users in relative orientation of the neck 17 and the second pipe 15 in the circumferential direction, the step concave portion 59 can be placed within the inversed triangle of the groove 61.

The depth of this groove 61 is not limited, but it is desirable that the depth ensure sufficient strength at least of the neck 17 and the second pipe 15 during use, and when the water generated in the mouthpiece 21 and at the top side of the neck 17 flows in, in a state of placement of the saxophone during use, allow the water to be guided to flow down easily.

It is necessary that the groove 61 is placed at a position apart from any of the high F#, high F, high E b, high D, and all the other tone holes 23 opened/closed using left hand. The groove 61 preferably extends for a length going down to be at least lower than the B tone hole 23e, desirably lower than the G tone hole 23f, more desirably lower than the G# tone hole 23g. The groove 61 may also be provided, extending over the entire length of the second pipe 15.

In this embodiment, to form the groove 61 linearly along the axis Ls of the second pipe 15, tone holes 23 that might come adjacent to or overlap with the groove 61 are placed, deviated in the circumferential direction, to become apart from the groove 61. Here, one or both of the high F# tone hole 23a and high F tone hole 23b are moved in the circumferential direction to become apart from the groove 61. This allows the groove 61 to be placed within the front region 65, and the width of the groove 61 becomes narrower than that of the front region 65. The width of the groove 61 on the side of the neck 17 is wider than that of the front region 65.

The inner surface of such a step concave portion 59 and the groove 61 may be a hydrophilically treated surface. In this case, the hydrophilic property of the surface of the step concave portion 59 can be increased to become higher than that of the internal wall surface of the neck 17, or the hydrophilic property of the hydrophilically treated inner surface of the groove 61 can be increased to become higher than that of the second pipe 15.

According to such a saxophone 10, the fluid, namely condensation of saliva and breath within the mouthpiece 21 and neck 17 flowing down within the neck 17, flows down toward the front side of the neck 17 depending on the placement conditions during use. The fluid then flows into the step concave portion 59, where it is guided into the groove 61, in which it is guided toward the first pipe 13 to flow down. The fluid generated at the top side of the second pipe 15 and flowing into the groove 61 is also guided into the side of the first pipe 13 within the groove 61 to flow down.

As a result, the fluid is not allowed to reach easily the high F#, high F, high E b, high D tone holes 23a, 23b, 23c, 23d of the second pipe 15 placed on the side of the neck 17, and other tone holes 23 of the second pipe 15 opened/closed by left hand. Consequently, the amount of fluid leaking out of each tone hole 23 can be decreased. Furthermore, adverse effect on the sound of the saxophone 10 can be prevented.

In the above embodiment, the groove 61 in linear configuration was described. However, its shape is not limited, and the groove 61 may be formed in a curved shape within the scope where fluid can be guided.

Furthermore, in the above embodiment, the example where the water guiding means is made of the step concave portion 59 and the groove 61 was described. However, it is also possible to use it along with a water guiding means 40 according to other embodiments, linear or curved protrusions may be used, for example. In this case, by providing a plurality of protrusions protruding inward next to each other within the neck 17 and the second pipe 15, the gaps between the plurality of protrusions can be used as the step concave portion or the groove.

In the above embodiment, the example where the groove 61 and the front region 65 are provided by adjusting the positions of some or all of the tone holes 23 was described, but the positions of the tone holes 23 may not have to be adjusted. If the tone holes 23 in proximity to the front center line Lf are placed in positions overlapping with the front region 65 and the groove 61, it is possible to provide a peripheral wall 55 for each of the tone holes 23 as in embodiments 3 to 5. Consequently, the amount of fluid leaking out of each tone hole 23 can be decreased even if the tone holes 23 are overlapping with the front region 65 or the groove 61.

### Sixth embodiment

The saxophone 10 in the sixth embodiment is equipped with a water guiding means 40 between the mouthpiece 21 and the first pipe 13 in order that the fluid blown from the mouthpiece 21 flows down along a position within the pipe different from tone hole 23 openings.

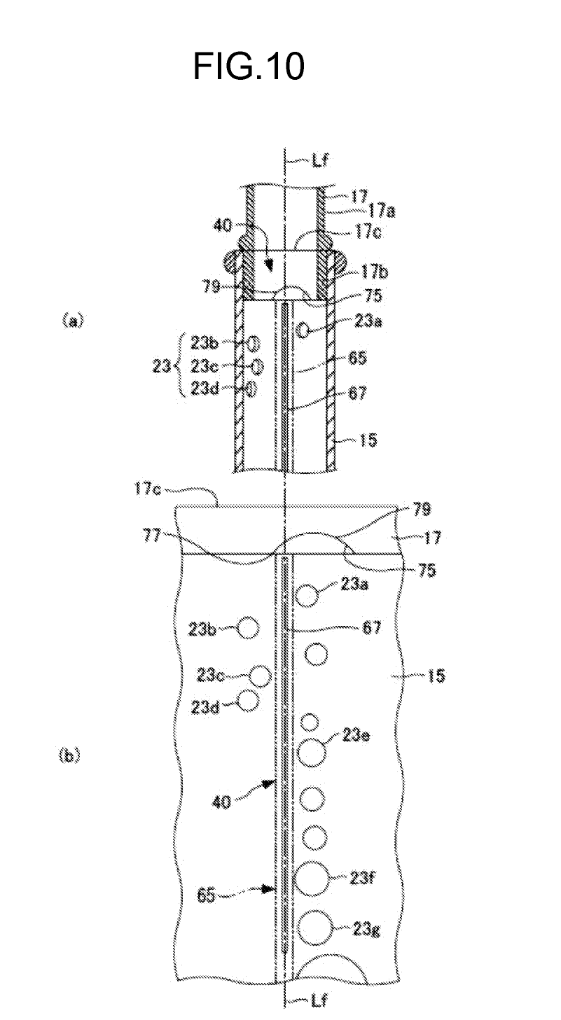

As shown in FIG. 10(a) and FIG. 10(b), the water guiding means 40 has a streaky protrusion 67 that extends in the longitudinal direction of the second pipe 15 on the front internal wall surface of the second pipe 15. This embodiment further includes a guiding configuration made of a guiding step 75 and a flow-down end 77 as a water guiding means 40 at the connecting part where the neck 17 is connected to the second pipe 15, more specifically at a position where the neck matches the end of the second pipe 15.

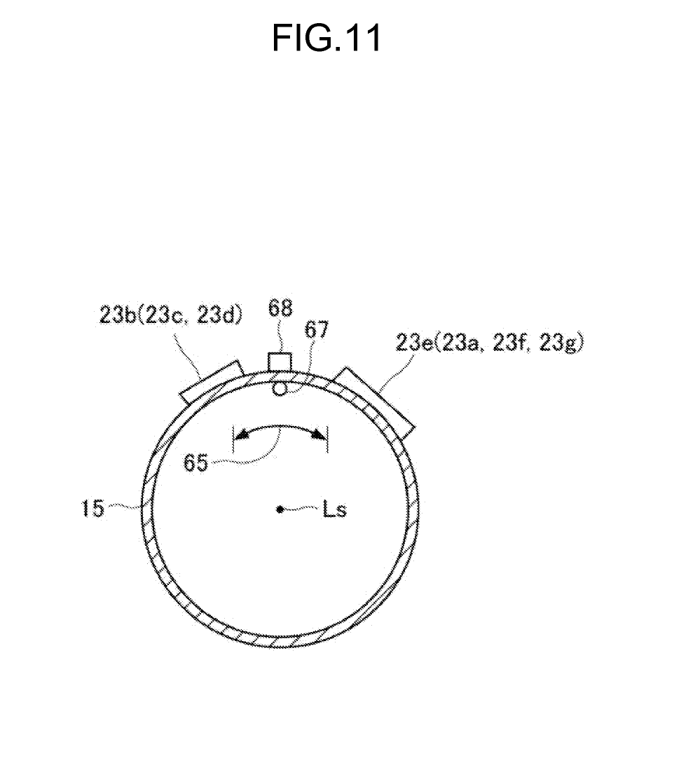

As shown in FIGS. 10 and 11, the streaky protrusion 67 protrudes inward from the inner wall surface, and extends in the longitudinal direction, of the second pipe 15. This streaky protrusion 67 may be in a curved shape in the longitudinal direction, but is favorably formed in linear shape to facilitate guidance of the fluid. The amount of protrusion of the streaky protrusion 67 is not limited, provided that the maximum amount of inward protrusion from the inner wall surface of the second pipe 15 does not have adverse effect on sound quality, etc. and that the height can block the fluid flowing in the circumferential direction on the inner wall surface.

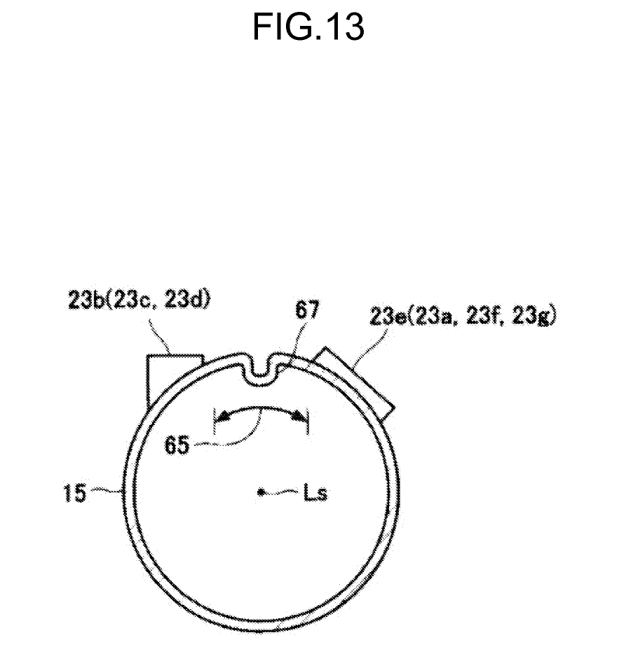

As shown in FIG. 13, the streaky protrusion 67 may be formed by deforming the pipe wall of the second pipe 15 to allow the pipe wall to protrude inward, but it is favorable that a long member different from the pipe wall is fastened on the inner wall surface of the second pipe 15 as shown in FIG. 11 because processing is easy.

As such long members, those attachable to the inner wall of the second pipe 15 can be used. As the long member, linear members in a shape of lines, rods or plates made of a resin, metal, ceramics, etc. may be used. In this embodiment, a magnetic metal body in a shape of a rod is used.

As shown in FIGS. 10 and 11, this streaky protrusion 67 is provided in the front region 65 that extends along the axis Ls of the second pipe 15 on the front inner wall surface of the second pipe 15. As described above, the front region 65 includes the front center line Lf.

In this embodiment, by adjusting the positions of some or all of the tone holes 23, high F, high E b, and high D tone holes 23b, 23c, 23d are placed on one side of the front region 65, and on the other side, B, G, and G# tone holes 23e, 23f, 23g are placed. The streaky protrusion 67 is therefore placed among these tone holes 23 without contacting the tone holes 23.

When adjusting the positions of the tone holes 23 as described above, by increasing the amount of vertical overlapping between high F or high E b tone hole 23b, 23c and high D tone hole 23d, the width of the front region 65 can be ensured relatively easily. In this case, by curving or bending the lever for operating key touches 27, the positions can be adjusted easily without degrading the opening/closing operability.

As the position of the streaky protrusion 67 in the vertical direction, it is desirable that the top end of the streaky protrusion 67 is placed at a position at least higher than the B tone hole 23e, favorably higher than the high E b tone hole 23c, and more preferably at a position higher than the high F tone hole 23b in the proximity of the neck 17. Meanwhile, the bottom end of the streaky protrusion 67 should be at a position at least lower than the B tone hole 23e, preferably lower than the G tone hole 23f, and more preferably lower than the G# tone hole 23g.

As described later, thanks to such positional arrangement, the streaky protrusion 67 surely allows the water that flows down from the neck 17 on the side of the high D tone hole 23d to flow down without being moved to the side of the B tone hole 23e. In particular, even if the saxophone 10 is swayed during performance, the circumferential movement of the water flowing down can be blocked by the streaky protrusion 67.

When a linear member or a rod-shaped body is used as the streaky protrusion 67, the linear member or the rod-shaped body can be fastened to the second pipe 15 by a method selected from adhesion, welding, brazing, soldering, magnetically absorbing, screwing, calking, etc. as required depending on the member used.

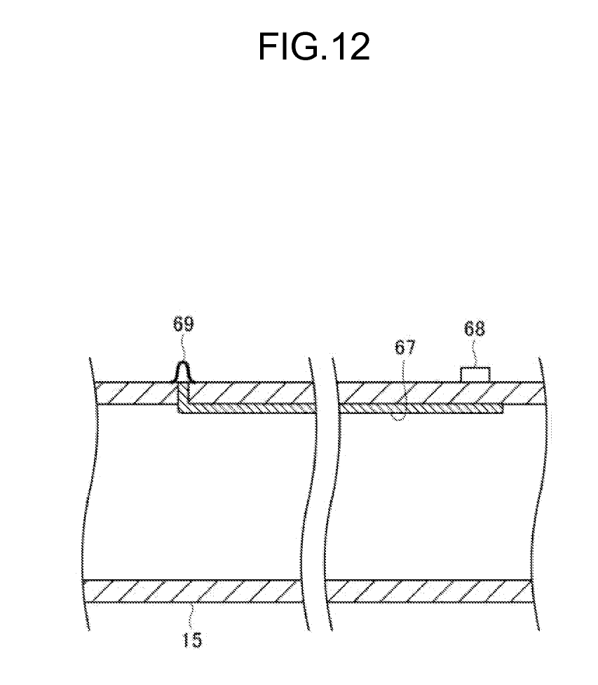

Since a metal rod-shaped body that can be attached by magnetically absorbing is used as the streaky protrusion 67 in this embodiment, it is fastened using a magnet 68 provided on the second pipe 15 and a machine screw 69 for screwing or calking as shown in FIG. 12. The bottom end of the rod-shaped body is arranged on the bottom side within the second pipe 15 in folded or curved state, and fastened to the pipe wall by screwing or by calking using the machine screw 69, with its edge penetrating toward outside of the second pipe 15. If the bottom side is folded or curved in this way, cloths, etc. do not get stuck easily when interior of the second pipe 15 is cleaned using cloths, etc., which is favorable. Meanwhile, the top end of the rod-shaped body is placed on the top side within the second pipe 15, and attached to the pipe wall by magnetic force of the magnet 68 placed outside the second pipe 15.

The guiding step 75 and the flow-down end 77 provided in a region where the neck 17 is fitted to an end of the second pipe 15 are in a shape allowing water droplets generated on the inner surface of the neck 17 to flow down by gravity, running through these shapes.

In this embodiment, as shown in FIG. 10, they are formed by providing a cutout 79 in a curved shape at the bottom end of the neck 17. Here, by cutting out the end of the neck 17 to be fitted to the second pipe 15, a step is formed in a radial direction between the inner periphery of the second pipe 15 and the inner periphery of the neck 17 on the bottom side when they are fitted. This guiding step 75 has an inclination in the circumferential direction so that water droplets having flowed down on the internal wall surface of the neck 17 and reached the guiding step 75 can flow down, running through the edge of the guiding step 75.

It is only necessary to form the curved shape of the cutout 79, so that the curved shape can guide water when the top side of the second pipe 15 is placed, with the top side slightly inclined forward during use, and within a range where the rigidity and air-tightness of the connecting part of the neck 17 can be ensured. In this embodiment, the cutout 79 is provided in a range of ⅕ of the circular connecting part or larger, more preferably ⅓ or larger, of the neck 17.

The flow-down end 77 is at the bottom end of this guiding step 75, and is the end of the cutout 79 formed on the circular bottom end of the neck 17 disposed in a direction orthogonal to the axis Ls of the second pipe 15.

In the case of this embodiment, two ends are provided on the guiding step 75 by forming the cutout 79, and the end that comes on the front side during use serves as the flow-down end 77. It is favorable that this flow-down end 77 is placed in a position on the side of the high D tone hole 23d with respect to the streaky protrusion 67 and in proximity to the streaky protrusion 67. It may be placed in the front region 65 or in proximity to the front region 65, in particular. Once water flows down from the neck 17 to this position, the water attaches to and flows down along the streaky protrusion 67, and consequently the water can be made to flow down without contacting the high F, high E b, high D tone holes 23b, 23c, 23d and the B, G, and G# tone holes 23e, 23f, 23g.

With the saxophone 10 in this embodiment, the fluid having attached to the inner wall surface of the neck 17 flows down on the inner wall surface of the neck 17 and reaches the guiding step 75, is guided through the guiding step 75 to the flow-down end 77, and then flows down from the flow-down end 77.

Since the flow-down end 77 is at a specified position, the water flows down to the second pipe 15 on the side of the high D tone hole 23d with respect to the front center line Lf. The fluid flows down on and attaches to the internal wall surface of the second pipe 15 in the front region 65 of the second pipe 15 or its neighborhood, and flows down to the side of the first pipe 13 in the front region 65. Favorably, the water that has flowed down to the second pipe 15 attaches to the edge on the side of the high D tone hole 23d with respect to the streaky protrusion 67, and is guided by the streaky protrusion 67 to flow down to the first pipe 13.

Consequently, the water can flow down to the first pipe 13 without reaching the high F and high E b tone holes 23b, 23c of the second pipe 15 on the side of the neck 17, and furthermore the tone holes 23 for left hand of the second pipe 15. Furthermore, the water flowing down on one side of the streaky protrusion 67 can be prevented thoroughly from moving to the other side. There is a case, for example, where water flows down, zigzagging on the internal wall surface of the second pipe 15 when the saxophone 10 is swayed or its orientation is changed. In this case, the water flowing down to the first pipe 13 moves in the circumferential direction of the second pipe 15. However, since the streaky protrusion 67 serves as a weir, the water does not move to the side of the high F# and B tone holes 23a, 23e beyond the streaky protrusion 67.

It is therefore possible to minimize the amount of water leaking out of each tone hole 23, or eliminate it. Furthermore, such structure prevents adverse effect on the sound of the saxophone 10.

The above embodiment can be modified as required within the scope of the present invention. In the above embodiment, the water guiding means 40 has a streaky protrusion 67 and a flow-down end 77 of the neck 17, but it is also possible to use it along with a water guiding means 40 according to other embodiments.

In the above embodiment, the water guiding means 40 is formed by the streaky protrusion 67 provided in the second pipe 15 and the guiding configuration made of the guiding step 75 and the flow-down end 77 provided in the neck 17. However, the water guiding means may be formed using only one item either the streaky protrusion 67 of the second pipe 15 or the guiding configuration in the neck 17. In that case also, it is possible to use it in combination with a water guiding means 40 according to other embodiments.

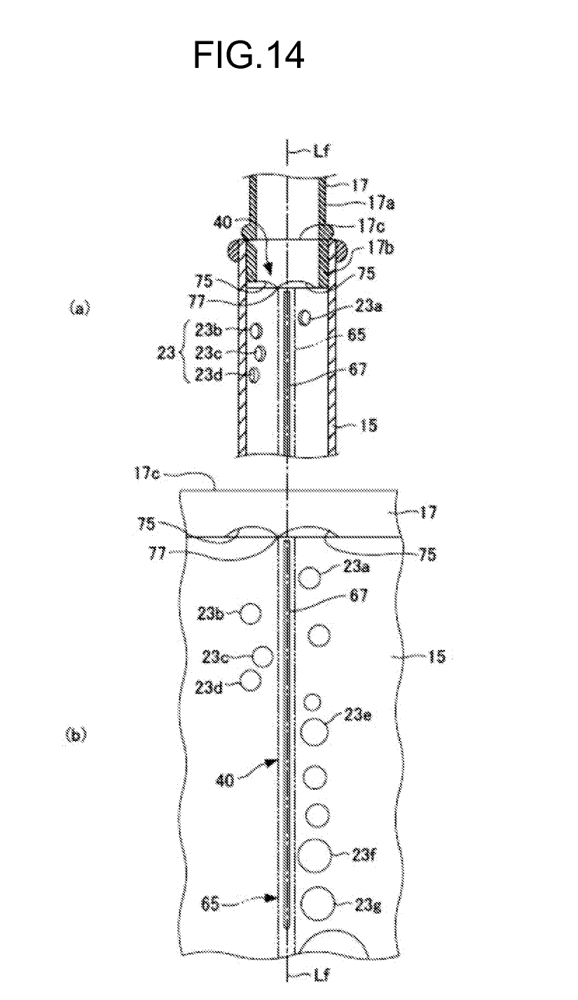

In the above configuration, the guiding step 75 is formed by providing a curved cutout at the bottom end of the neck 17, but the shape of the guiding step 75 and the flow-down end 77 is not limited at all. For example, as shown in FIG. 14, a pair of or a plurality of guiding steps 75 in a shape the same as or different from the above cutout 79 may be provided on both sides of the flow-down end 77. In this case, since the flow-down end 77 is placed at the lowest position of the neck 17 during performance, more amount of fluid having attached to the internal wall surface of the neck 17 can be guided to the flow-down end 77.

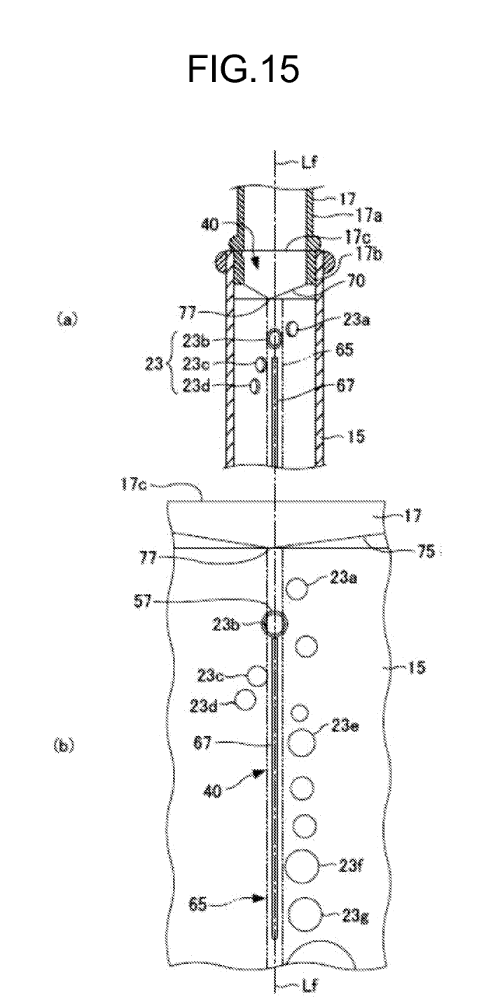

Furthermore, as shown in FIG. 15, the entire shape of the bottom end of the neck 17 may be inclined so that the flow-down end 77 comes at the bottom within a range where sufficient bonding strength can be assured.

In the above embodiment, the top end of the streaky protrusion 67 was arranged in the neighborhood of the neck 17. However, as shown in FIG. 15, the top end of the streaky protrusion 67 may be placed in a position apart from the bottom end of the neck 17, at a position lower than the high F tone hole 23b, for example. In this case, a protruding wall 57 as shown in the embodiments 2 to 4 can be provided for the high F tone hole 23b. This prevents the water traveling down from flowing out of this tone hole 23b even if it reaches the neighborhood of the high F tone hole 23b.

In the above embodiment, the example where the high F, high E b, and high D tone holes 23b, 23c, 23d are arranged on one side of the front region 65, whereas the B, G, and G# tone holes 23e, 23f, 23g are arranged on the other side, by adjusting the position of the tone holes 23 was described. However, this embodiment can be achieved even if the positions of the tone holes 23 are not adjusted. For example, as shown in FIG. 15, when tone holes 23 in the neighborhood of the front center line Lf are arranged in positions overlapped with the front region 65 or the streaky protrusion 67, peripheral wall 55 or protruding wall 57 as shown in embodiments 3 to 5 can be provided for each of the tone holes. Consequently, even the tone holes 23 placed at positions overlapped with the front region 65 and the groove 61 can suppress the amount of water leaking out of each tone hole 23.

In the above embodiment, the rod-shaped body as the streaky protrusion 67 was fastened using a magnet 68 and a machine screw 69, but it may be fastened using one or a plurality of magnets 68 only. The rod-shaped body can thus be attached/detached or its positions can be adjusted freely.

In the above embodiment, as a means to guide the water droplets generated on the inner wall surface of the neck 17 into the specified position in the second pipe 15, the guiding step 75 and flow-down end 77 were provided by forming a cutout 79 at the bottom end of the neck 17, but this means may be in other configurations. For example, a member different from the connecting part 17c of the neck 17 may be placed, contacting the inner wall surface on the bottom end side, and the shape of the bottom end may be slanted in the circumferential direction and a part of it may be protruded downward. In addition, a linear member in a shape ensuring liquid collection may be arranged on the internal surface of the neck 17 as in the case of the branching part of the suspended member 49 in the first embodiment, or a shape like the guiding step concave portion 59 in the fifth embodiment may be provided. Furthermore, flanges protruding inward may be provided on the edge of the guiding step 75, or protrusions such as rod-shaped bodies may be attached to the flow-down end 77 so that they protrude downward.

The first to the seventh embodiments described above are examples where the present invention was applied to the saxophone, but it is also possible to apply the present invention to other wind instruments.

### Reference Signs List

10: Saxophone
11: Bell
13: First pipe
15: Second pipe
17: Neck
19: Reed
21: Mouthpiece
23, 23a to 23g: Tone hole
25: Lever
27: Key touch
29: Pad
30: Water leakage prevention tool
40: Water guiding means
43: Protruding part
47: Fixing member
49: Suspended member
51: Linear member
53: Weight
55: Tone hole peripheral wall
57: Protruding wall
59: Step concave portion
61: Groove
65: Front region
67: Streaky protrusion
75: Guiding step
77: Flow-down end
79: Cutout

1. A saxophone, comprising: a roughly U-shaped first pipe communicating with a bell; and a second pipe, which communicates with the first pipe and into which breath blown into a mouthpiece flows through a neck,
characterized in that a water guiding means is provided between the mouthpiece and the first pipe to guide fluid within the breath to a side of the first pipe, and that the water guiding means allows the fluid to flow down through a different position within the second pipe from tone hole openings.

2. The saxophone as set forth in claim 1, wherein the water guiding means has a groove or a streaky protrusion that extends in a longitudinal direction of the second pipe on a front inner wall surface of the second pipe.

3. The saxophone as set forth in claim 2, wherein a front region extending along a central axis of the second pipe is provided on the front inner wall surface of the second pipe; high E b and D tone holes are arranged on one side, whereas B, G, and G# tone holes are arranged on the other side, across the front region; and the groove or the streaky protrusion is provided within the front region.

4. The saxophone as set forth in claim 3, wherein high F, high E b, and high D tone holes are provided on one side of the front region, and the groove or the streaky protrusion extends in the front region from a position above a center of the high F tone hole to a position at least lower than a center of the B tone hole.

5. The saxophone as set forth in claim 2, wherein the streaky protrusion is made of a long member fastened to the inner wall surface of the second pipe.

6. The saxophone as set forth in claim 2, wherein a step inclined in a circumferential direction and a flow-down end are provided, in a connecting part where the neck is connected to the second pipe, in order to guide the fluid attached to the inner wall surface of the neck to a flow-down position corresponding to the groove or the streaky protrusion.

7. The saxophone as set forth in claim 6, wherein the step and the flow-down end are formed by a cutout made in the connecting part.

8. The saxophone as set forth in one claim 1, wherein the water guiding means has a protruding wall protruding inward from the internal wall surface in a manner surrounding a circumference of each of the tone holes of the second pipe.

9. The saxophone as set forth in claim 1, wherein the water guiding means has a tone hole peripheral wall inclined so that its external side comes topside.

10. A wind instrument comprising a pipe body with tone holes into which breath flows from topside in a state positioned vertically,
characterized in that the pipe body is provided with a water guiding means for guiding fluid within the breath to downside of the pipe body, and that the water guiding means allows the fluid to flow down within the pipe body through a position different from the tone hole openings.

11. A water leakage prevention tool to be attached to saxophones having a roughly U-shaped first pipe communicating with a bell, and a second pipe, which communicates with the first pipe and into which breath having blown into a mouthpiece flows through a neck,
wherein, a water guiding means is provided between the mouthpiece and the first pipe to guide fluid within the breath to a side of the first pipe, and the water guiding means allows the fluid to flow down within the second pipe through a position different from tone hole openings.

12. The water leakage prevention tool for saxophones as set forth in claim 11, wherein the water guiding means has a long member placed within the second pipe and extending in a longitudinal direction.

13. The water leakage prevention tool for saxophones as set forth in claim 12, wherein the long member is laid out on a front inner wall surface of the second pipe.

14. The water leakage prevention tool for saxophones as set forth in claim 12, wherein the long member is suspended within the second pipe from a connecting part where the neck and the second pipe are connected, or from the neighborhood of the connecting part.

15. A saxophone to which the water leakage prevention tool for saxophones as set forth in claim 12 is attached.

16. A water leakage prevention tool for wind instruments that is attachable to wind instruments comprising a pipe body with tone holes into which breath is blown from topside in a state placed vertically,
wherein a water guiding means is attached to the pipe body to guide the fluid within the breath to lower side of the pipe body, and the water guiding means allows the fluid to flow down within the pipe body through a position different from the tone hole openings.
